(19) United States
(12) Patent Application Publication
(10) Pub. No.: US 2016/0217385 A1
(43) Pub. Date: Jul. 28, 2016

(54) METHOD AND APPARATUS FOR ANALYZING MISSING NOT AT RANDOM DATA AND RECOMMENDATION SYSTEM USING THE SAME

(71) Applicant: POSTECH ACADEMY-INDUSTRY FOUNDATION, Gyeongsangbuk-do (KR)

(72) Inventors: Seungjin CHOI, Gyeongsangbuk-do (KR); Yong-Deok KIM, Jeollabuk-do (KR)

(21) Appl. No.: 15/001,453

(22) Filed: Jan. 20, 2016

(30) Foreign Application Priority Data
Jan. 27, 2015 (KR) 10-2015-0012748

(51) Int. Cl. G06N 7/00; G06N 5/04; G06Q 30/06; G06N 99/00

(52) U.S. Cl. CPC G06N 7/005; G06N 99/005; G06N 5/04; G06Q 30/0623

(57) ABSTRACT

Disclosed are MNAR data analysis methods and apparatuses for analyzing user preference data on products. Also, a product recommendation system using the same is disclosed. A data analysis method based on a binomial mixture model comprises defining a binomial mixture model based data generation model for analyzing user preference data on products; defining a missing data mechanism model for explaining observation and missing of user preference data on the products; learning the data generation model and the missing data mechanism model based on observed user preference data on the products; and determining final preferences on products whose preferences are missing based on the learned data generation model and the learned missing data mechanism model.

### CROSS-REFERENCE TO RELATED APPLICATIONS

This application claims priority to Korean Patent Application No. 10-2015-0012748 filed on Jan. 27, 2015 in the Korean Intellectual Property Office (KIPO), the entire contents of which are hereby incorporated by reference.

### BACKGROUND

1. Technical Field

The present disclosure relates to a technology of analyzing product evaluation data of users, and more particularly to methods and apparatuses for analyzing mission not at random (MNAR) data and a product recommendation system using the same.

2. Related Art

According to advancement of internet and smart communication technologies, users can get information on products with easiness. However, since such the technology advancement provides users with too much information, time required for the user to select a desired product increases. Therefore, a method of filtering unnecessary information and providing only information of suitable products to the user, that is, a user customized product recommendation method, is being demanded.

The traditional product recommendation system uses a simple rule-based algorithm and recommends products customized for preference information of a user. After then, due to advancement of technologies, a current product recommendation system analyzes behavioral patterns and preferences of a user by using technologies of machine learning and data mining. Through this, the current product recommendation system can recommend products (information or content) which are predicted that the user prefers.

Various techniques for implementing the product recommendation system are being developed. Among them, a collaborative filtering technique is a well-known technique. For example, the collaborative filtering technique has been widely used in e-business websites such as Amazon or Netflix. The collaborative filtering technique is a technique of analyzing users having similar preference patterns based on preference information which users have assigned for respective products. Specifically, the technique may be explained by referring to a below table 1.

TABLE 1

| | Prod- | Prod- | Prod- | Prod- | Prod- | Prod- | Prod- | Prod- |
|---|---|---|---|---|---|---|---|---|
| | uct 1 | uct 2 | uct 3 | uct 4 | uct 5 | uct 6 | uct 7 | uct 8 |
| User 1 | 1 | ? | 1 | 1 | 2 | 2 | ? | 2 |
| User 2 | 4 | 3 | ? | ? | ? | ? | ? | ? |
| User 3 | 2 | 4 | 4 | ? | 5 | ? | 1 | ? |
| User 4 | 5 | 1 | ? | ? | ? | 1 | ? | ? |
| User 5 | ? | 2 | 1 | ? | 3 | 3 | ? | 4 |

The table 1 shows an example of a user-product preference matrix which can be applied to a system using a user preference rating of 5 levels. The collaborative filtering technique is used to predict values of elements represented as ‘?’. That is, the collaborative filtering technique may be understood as a matrix completion technique used for predicting missing elements based on partially observed elements of the matrix.

The causes of missing may be classified into a missing completely at random (MCAR), a missing at random (MAR), and a missing not at random (MNAR) according to whether the missing is generated completely at random, the missing is related to observed values of observed variables, or the missing is related to the missing value itself.

Most theories for the matrix completion techniques are based on the assumption of MCAR. However, it is difficult to apply the assumption of MCAR to the collaborative filtering technique. When analyzing data collected in most of recommendation systems, the number of ratings performed by respective users follows not a normal distribution but a power series distribution. Accordingly, the assumption of MAR in the collaborative filtering problem may mean that missing of the element Xᵢⱼ located at (i,j) of the user-product preference matrix X is effected by the user identification number i and the product identification number j not by the value of Xᵢⱼ. Thus, most of the collaborative filter techniques which have been developed until now are based on the assumption of MAR.

In the case that data follow the MAR model, missing data mechanism can be ignored, and estimation of parameters according to it is unbiased. However, in the collaborative filtering problem, a strong evidence that data do not follow the MAR model has already been proposed in a below reference 1.
[Reference 1] B. M. Marlin, R. S. Zemel, S. T. Roweis. “Collaborative filtering and the missing at random assumption”, In Proceedings of the Annual Conference on Uncertainty in Artificial Intelligence (UAI), Vancouver, Canada, 2007.

It can be intuitively understood from the below examples that the assumption of MAR can be easily broken in a recommendation system.

(1) A user selects only preferred products, and rates only selected products.

(2) A user selects only products for which his likes and dislikes are clear, and rates only selected products.

In the above examples, since missing data have direct relevance to the missing, the assumption of MAR is not valid. That is, when the assumption of MAR is not valid, estimation of parameters ignoring the missing data mechanism may be biased whereby the prediction performance significantly degrades.

### SUMMARY

Accordingly, exemplary embodiments of the present invention are provided to substantially obviate one or more problems due to limitations and disadvantages of the related art.

Exemplary embodiments according to the present disclosure provide methods and apparatuses of analyzing data following MNAR mechanism as technologies of analyzing data of user preference rating on products.

Exemplary embodiments according to the present disclosure also provide a product recommendation system using the above-described data analysis methods and apparatuses.

In order to achieve the objectives of the present invention, an aspect of a MNAR data analysis method based on a binomial mixture model may comprise defining a binomial mixture model based data generation model for analyzing user preference data on products; defining a missing data mechanism model for explaining observation and missing of user preference data on the products; learning the data generation model and the missing data mechanism model based on observed user preference data on the products; and determining final preferences on products whose preferences are missing based on the learned data generation model and the learned missing data mechanism model.

Here, the binomial mixture model based data generation model may be defined based on assumption that users are grouped into a plurality of groups having similar preferences, assumption that user preferences on products follow a binomial distribution model, and assumption that users belonging to a same group share parameters of the binomial distribution model.

Here, the missing data mechanism model may be based on three factors including user activities, popularities of products, and rating value based selection effects, and the three factors are represented as binary variables. Also, whether a specific user's preference on a specific product is observed or missing may be determined through a Boolean OR operation on the three factors.

Here, the learning the data generation model and the missing data mechanism model may comprise representing a posterior distribution of random variables constituting probability models of the data generation model and the missing data mechanism model as multiplication of parametric functions respectively defined for the random variables through mean field approximation based on variational inference; extracting a lower-bound function of marginalized log likelihood for observed variables based on the parametric functions; and learning parameters of the parametric functions maximizing the extracted lower-bound function. Also, in the learning parameters of the parametric functions, a plurality of parameters included in the parametric functions may be sequentially updated until a change amount of the lower-bound function of marginalized log likelihood becomes less than a threshold.

Here, the method may further comprise analyzing a trend of the observed user preference data based on the learned data generation model and missing data mechanism model.

In order to achieve the objectives of the present invention, another aspect of a MNAR data analysis method based on a binomial mixture model may comprise defining probability models for analyzing the MNAR data and defining an analysis model by assigning a posteriori distribution to variables constituting the probability models; learning the analysis model through a variational inference for respective variables constituting the analysis model; and predicting missing data based on the learned analysis model. Also, the probability models may include a binomial mixture model based data generation model and a missing data mechanism explaining observation and missing of user preference data on products.

Here, the method may further comprise determining final preferences on products whose preferences are missing based on the predicted missing data.

Here, the method may further comprise analyzing a trend of observed user preference data based on the predicted missing data.

Here, the method may further comprise transmitting product recommendation information including final preferences determined for products whose preferences are missing based on the predicted missing data or product recommendation information including a trend of observed user preference data analyzed based on the predicted missing data.

In order to achieve the objectives of the present invention, a data analysis for analyzing MNAR data based on a binomial mixture model may comprise a memory unit storing a program code; and a processor which is connected to the memory unit and executes the program code. Also, the program code may include a step of defining probability models for analyzing the MNAR data and defining an analysis model by assigning a posteriori distribution to variables constituting the probability models; a step of learning the analysis model through a variational inference for respective variables constituting the analysis model; and a step of predicting missing data based on the learned analysis model. Also, the probability models may include a binomial mixture model based data generation model and a missing data mechanism explaining observation and missing of user preference data on products.

In order to achieve the objectives of the present invention, a product recommendation system including a service apparatus for analyzing missing not at random (MNAR) data based on a binomial mixture model may be provided. In the product recommendation system, the service apparatus defines probability models for analyzing the MNAR data and defining an analysis model by assigning a posteriori distribution to variables constituting the probability models, learns the analysis model through a variational inference for respective variables constituting the analysis model, and predicts missing data based on the learned analysis model. Also, the probability models may include a binomial mixture model based data generation model and a missing data mechanism explaining observation and missing of user preference data on products.

The data analysis method or apparatus according to the present disclosure may analyze user preference data on products based on a binomial mixture model as a direct mathematical modeling whereby performance degradation of the conventional collaborative filtering can be avoided and trends of user preference ratings can be analyzed very effectively.

In addition, the data analysis method or apparatus according to the present disclosure may analyze user preference data on products according to a MNAR data mechanism based on a Bayesian binomial mixture model whereby performance degradation of the conventional collaborative filtering based on assumption of MAR can be avoided and trends of user preference ratings can be analyzed. Also, performances of various product recommendation systems can be evaluated based on the performance of the method and apparatus according to the present disclosure.

Furthermore, the product recommendation system using the data analysis method and apparatus according to the present disclosure can avoid performance degradation of prediction ignoring a missing data mechanism causing biased estimation of parameters when the assumption of MAR is not established, thereby providing optimal product recommendation services based user preference data on products.

### BRIEF DESCRIPTION OF DRAWINGS

Exemplary embodiments of the present invention will become more apparent by describing in detail exemplary embodiments of the present invention with reference to the accompanying drawings, in which:

FIG. 1 is a conceptual diagram illustrating a binomial mixture model based analysis model for analyzing user preference data following the MNAR property according to an exemplary embodiment of the present disclosure;

FIGS. 2A to 2D illustrate graphs illustrating comparison between results of preference prediction using the binominal mixture model based analysis model according to an exemplary embodiment of the present disclosure and results of preference prediction according to a comparative method;

FIG. 3 is a block diagram illustrating a MNAR data analysis apparatus according to another exemplary embodiment of the present disclosure; and

FIG. 4 is a block diagram illustrating a product recommendation system using MNAR data analysis methods or apparatuses according to an exemplary embodiment of the present disclosure.

### DETAILED DESCRIPTION

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” with another element, it can be directly connected or coupled with the other element or intervening elements may be present. In contrast, when an element is referred to as being “directly connected” or “directly coupled” with another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present invention will be described in detail with reference to the appended drawings. In the following description, for easy understanding, like numbers refer to like elements throughout the description of the figures, and the same elements will not be described further.

Methods of Analyzing Missing Data

In a case that missing data exist in a data matrix X={Xᵢⱼ} (i=1, . . . , I, j=1, . . . , J), an observation indicator Rᵢⱼ may be defined as a below equation 1.

$${R}_{ij} = \{ \{ \begin{matrix}1 , & if {X}_{ij} is observed \\ 0 , & if {X}_{ij} is missing\end{matrix} \qquad [ Equation 1 ]$$

An observation indication matrix may be represented as R={Rᵢⱼ}. Analysis on a data matrix where missing data exist is based on a joint distribution of the data X and the observation indication matrix R. As a method for modeling such the joint distribution, a selective model and a pattern-mixture model are available (refer to a below reference 2).
[Reference 2] R. J. A. Little and D. B. Rubin, “Statistical analysis with missing data”, John Wiley & Sons, Inc., chapters 15.4 to 15.6, 1986.

The data analysis method proposed by an exemplary embodiment of the present disclosure is based on the selective model. The selective model models the joint distribution of the data X and the observation indication matrix R by dividing it into a marginal distribution of X and a conditional distribution of R when X is given. It may be represented as a below equation 2.

p(R,X|θ,Y)=p(X|θ)p(R|X,Y) [Equation 2]

Here, (θ,Y) may respectively represent parameters of the marginal distribution of X and parameters of the conditional distribution of R when X is given. In the present exemplary embodiment, the marginal distribution of X may be referred to as a complete data model, and the conditional distribution of R when X is given may be referred to as a missing data mechanism model.

For the missing data mechanism model p(R|X,Y), analysis may be performed under assumption such as missing completely at random (MCAR), missing at random (MAR), or missing not at random (MNAR). If the missing data mechanism is under MCAR or MAR and the parameters θ and Y are distinct, the conditional distribution of R for the given data X in the selective model of the equation 2 may be ignored (referred to as ‘ignorable missing data mechanism’). The estimation of the parameter θ may be performed only based on the marginal distribution of X.

However, if the missing data mechanism is under MNAR, the parameter estimation ignoring the missing data mechanism may cause a significant biased result. In this case, parameters of the complete data model and the missing data mechanism model should be learned with together. In a case of collaborative filtering problem, a significant proof that data do not follow assumption of MAR has been proposed (refer to the reference 1). In exemplary embodiments of the present disclosure, methods for analyzing MNAR data which are suitable to the collaborative filtering are provided.

Binomial Mixture Model Based MNAR Data Analysis Model

In an exemplary embodiment, user preference data on products may be represented as a matrix Xε{1, 2, . . . , V}^{I×J}. Here, Xᵢⱼ may mean a user preference of a i-th user on a j-th product. Also, it is assumed that the user preference is rated with a preference value of V levels (i.e., 1, 2, 3, . . . , V). In this case, a situation in which the i-th user evaluates only a portion of a plurality of products may happen. Accordingly, the matrix X may include at least one product whose user preference rating value does not exist. Here, a set of entries (i,j) whose preference values are observed may be represented as Ω, and a set Ω^{C} which is a complementary set of Ω is a set of entries (i,j) whose preference values are missing.

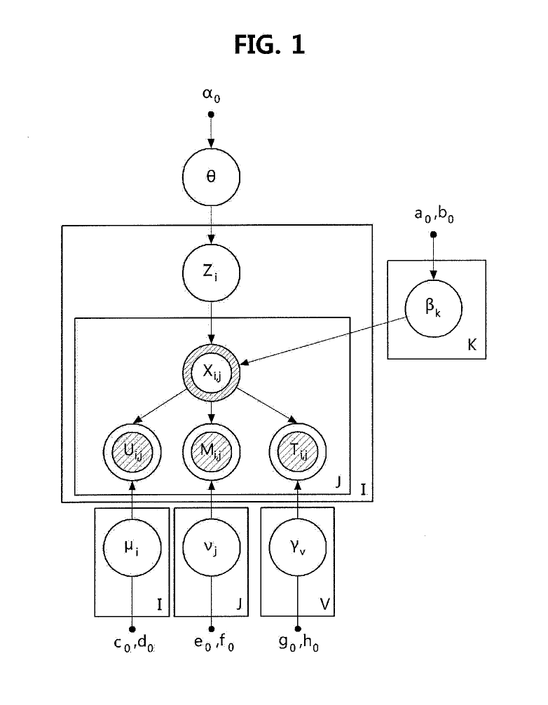

FIG. 1 is a conceptual diagram illustrating a binomial mixture model based analysis model for analyzing user preference data showing the MNAR property according to an exemplary embodiment of the present disclosure. Hereinafter, the analysis model may be referred to as ‘binomial mixture/OR model’.

The binomial mixture/OR model may be divided into a step of generating user preference data on products (a complete data generation model) and a step of determining observation and missing of the user preference data on the products based on user activities, popularities of products, and rating value based selection effects (a missing data mechanism model).

In the data analysis method proposed in the present exemplary embodiment, the complete data generation model may be based on assumption that users are grouped into a plurality of groups having similar tendencies, assumption that user preferences on products follow a binomial distribution, and assumption that users belong to a same group share parameters of the binomial distribution model. The method may be described as following steps 1 to 5.

Step 1:

Determining the number of groups, K

Step 2:

A parameter θ, which represents a mixing proportion of groups, may be generated from a symmetric Dirichlet distribution.

θ˜Dir(θ|α₀,K) [Equation 3]

Here, the parameter θ which represents the mixing proportion is a K-dimensional vector, and α₀ is a parameter representing a concentration in the symmetric Dirichlet distribution.

Step 3:

A parameter β, which represents a success probability of the binomial distribution, may be generated under a beta distribution.

$$β ∼ {\prod }_{k = 1}^{K} {\prod }_{j = 1}^{J} Beta ( {β}_{kj} \vert {a}_{0} , {b}_{0} ) \qquad [ Equation 4 ]$$

Here, β is a K×J matrix, whose element βₖⱼ is a parameter representing a preference value on a j-th product of a k-th group. βₖⱼ may have a value from 0 to 1. Also, the larger βₖⱼ may mean the higher preference. Here, a₀ and b₀ are parameters determining a shape of the beta distribution.

Step 4:

For each user iε{1, . . . , l}, a group to which the user belongs may be determined based on a multinomial distribution such as a below equation 5.

$${z}_{i} \vert θ ∼ Mult ( {z}_{i} \vert θ ) = {\prod }_{k = 1}^{K} {θ}_{k} {z}_{ki} \qquad [ Equation 5 ]$$

Here, Z is a K×1 matrix, and Zᵢ is a i-th row of the matrix Z. The element Zₖᵢ may be defined as a below equation 6.

$${Z}_{ki} = \{ \begin{matrix}1 , & i \text{-} th user belongs to a group K \\ 0 , & i \text{-} th user does not belong to the group K\end{matrix} \qquad [ Equation 6 ]$$

Step 5:

Preferences of respective users on respective products Xᵢⱼ (i=1, . . . , I, j=1, . . . , J) may be generated from a binomial distribution of a below equation 7.

$${X}_{ij} \vert {z}_{i} , β ∼ {\prod }_{k = 1}^{K} \text{Bin} {( {X}_{ij} \vert {β}_{kj} , V - 1 )}^{{Z}_{ki}} \qquad [ Equation 7 ]$$

Here, a preference rating of the i-th user belonging to the k-th group on the j-th product may be identical to the number of heads plus 1, when a probability of head is βₖⱼ and the coin is tossed (V−1) times. For example, if the heads of coin do not happen even a single time, the smallest rating 1 is given. Also, if the heads of coin happen V−1 times, the highest rating V is given.

Also, in the data analysis method proposed in the present exemplary embodiment, the missing data mechanism model is based on, as factors affecting missing of user preference data on products, user activity, popularity of the product, and rating value based selection effect. The above three factors are represented respectively as binary variables, and it may be determined through a Boolean OR operation on the three binary variables whether a specific user's preference on a specific product is observed or missing. The model may be described as following steps 1 to 4.

Step 1:

A success probability of a Bernoulli distribution may be generated for each user from a beta distribution having a parameter μ. The parameter μ may be interpreted as user activity.

$$μ ∼ {\prod }_{i = 1}^{I} Beta ( {μ}_{i} \vert {c}_{0} , {d}_{0} ) \qquad [ Equation 8 ]$$

Here, μ is an I-dimensional vector, and c₀ and d₀ are parameters determining a shape of the beta distribution.

Step 2:

For each product, a success probability of the Bernoulli distribution may be generated from a beta distribution having a parameter ν. The parameter ν may be interpreted as popularity of the product.

$$ν ∼ {\prod }_{j = 1}^{J} B ( {ν}_{j} \vert {e}_{0} , {f}_{0} ) \qquad [ Equation 9 ]$$

Here, ν is an J-dimensional vector, and e₀ and f₀ are parameters determining a shape of the beta distribution.

Step 3:

For each rating value, a success probability of Bernoulli distribution may be generated from a beta distribution of a parameter γ. The parameter γ may be interpreted as the rating value based selection effect for the user.

$$γ ∼ {\prod }_{v = 1}^{V} Beta ( {γ}_{v} \vert {g}_{0} , {h}_{0} ) \qquad [ Equation 10 ]$$

Here, γ is a V-dimensional vector, and g₀ and h₀ are parameters determining a shape of the beta distribution.

Step 4:

Observation or missing Rᵢⱼ (i=1, . . . , I, j=1, . . . , J) for preferences of respective users on respective products Xᵢⱼ (i=1, . . . , I, j=1, . . . , J) may be determined as a Boolean OR operation of binary variables as a below equation 11.

R^{ij}=Uᵢⱼ [symbol] Mᵢⱼ [symbol] Tᵢⱼ=1−(1−Uᵢⱼ)(1−Mᵢⱼ)(1−Tᵢⱼ) [Equation 11]

Here, Uᵢⱼ is a binary variable, which represents that the observation of the i-th user's rating on the j-th product is caused by the activity of the user. Also, it may be generated through a Bernoulli trial of a below equation 12.

Uᵢⱼ|Xᵢⱼ,μ˜Bern(Uᵢⱼ|μᵢ) [Equation 12]

Here, Mᵢⱼ is a binary variable, which represents that the observation of the i-th user's rating on the j-th product is caused by the popularity of the product. Also, it may be generated through a Bernoulli trial of a below equation 13.

Mᵢⱼ|Xᵢⱼ,ν˜Bern(Mᵢⱼ|νⱼ) [Equation 13]

Here, Tᵢⱼ is a binary variable, which represents that the observation of the i-th user's rating on the j-th product is caused by the rating based selection effect. Also, it may be generated through a Bernoulli trial of a below equation 14.

Tᵢⱼ|Xᵢⱼ,γ˜Bern(Tᵢⱼ|γxᵢⱼ) [Equation 14]

According to the equation 11 and a probability distribution of the equation 12 defined for the binary variables used in the equation 11, when the rating of the i-th user on the j-th product is v based on the equations 13 and 14, the observation probability of Xᵢⱼ may be calculated as a below equation 15.

$$\begin{matrix}p ( {R}_{ij} = 1 \vert {X}_{ij} = v ) = 1 - p ( {R}_{ij} = 0 \vert {X}_{ij} = v ) \\ = 1 - p ( {U}_{ij} = 0 , {M}_{ij} = 0 , {T}_{ij} = 0 \vert {X}_{ij} = v ) \\ = 1 - ( 1 - {μ}_{i} ) ( 1 - {v}_{j} ) ( 1 - {γ}_{v} )\end{matrix} \qquad [ Equation 15 ]$$

Model Learning Through a Variational Inference

Learning of the binomial mixture/OR model which is applied to the MNAR data analysis may be performed by deriving a posteriori distribution of the set S which is a set of non-observed variables based on a priori distribution defined for a set D which is a set of observed variables and observed values. The set D and the set S may be represented as below equations 16 and 17.

D={X_{Ω},U_{Ω}_{^{c}},M_{Ω}_{^{c}},T_{Ω}_{^{c}}} [Equation 16]

S={θ,β,μ,ν,γ,X_{Ω}_{^{c}},Z,U_{Ω},M_{Ω},T_{Ω}} [Equation 17]

In the variational inference, a parametric function q(S) maximizing a lower-bound function L(q) of a log of marginal likelihood log p(X_{Ω}) may be searched and the posteriori distribution function may be approximated by using it. The relation between such the functions may be represented as a below equation 18.

$$\begin{matrix}log p ( D ) = log \int p ( D , s ) d S \\ \geq log \int q ( S ) log \frac{p ( D , S )}{q ( S )} d S ≡ L ( q )\end{matrix} \qquad [ Equation 18 ]$$

In the MNAR data analysis method according to an exemplary embodiment, the parametric function q(S) may be decomposed into respective random variables and learned by using a mean-field approximation method as represented in a below equation 19.

q(S)=q(θ)q(β)q(μ)q(ν)q(γ)q(X_{Ω}_{^{c}},Z)q(U_{Ω},M_{Ω},T_{Ω}) [Equation 19]

Here, θ, β, μ, ν, γ are parameters used for the binomial mixture/OR model, X_{Ω}_{^{c}} is a missing preference of a user on a product, Z is an indicator representing which group the user belongs to, and U_{Ω}, M_{Ω}, and T_{Ω} are indicators explaining causes of observation on the observed user's preference on the product. That is, they are indicators for the user activities, the product popularities, and the rating value based selection effects, which are assumed in the model according to an exemplary embodiment.

A solution maximizing the lower-bound function L(q) is determined for the parametric function q(S) for respective random variables. Specifically, the solution may be represented as following equations 20 to 35. The actual learning procedure may be performed by repetitively calculating the below equations 20 to 35 until a change amount of the lower-bound function L(q) becomes less than a threshold and thus the algorithm is determined to be converged.

$$\begin{matrix}q ( θ ) = Dir ( θ \vert α ) & [ Equation 20 ] \\ for k ∈ \{ 1 , … , K \} \\ {α}_{k} = {α}_{0} + {\sum }_{i = 1}^{I} 〈 {Z}_{ki} 〉 , \\ 〈 {θ}_{k} 〉 = {α}_{k} \text{/} {\sum }_{k = 1}^{K} {α}_{k} , \\ 〈 log {θ}_{k} 〉 = ψ ( {α}_{k} ) - ψ ( {\sum }_{k = 1}^{K} {α}_{k} ) & [ Equation 21 ]\end{matrix}$$

Here, the equation 20 is the parametric function for θ, and the equation 21 is an update formula for θ, and ψ(•) is a digamma function.

$$\begin{matrix}q ( β ) = {\prod }_{k = 1}^{K} {\prod }_{j = 1}^{J} Beta ( {β}_{kj} \vert {α}_{kj} , {b}_{kj} ) & [ Equation 22 ] \\ for ( k , j ) ∈ \{ 1 , … , K \} \times \{ 1 , … , J \} \\ {ξ}_{kj} = {\sum }_{i ∈ {Ω}_{j}} {X}_{ij} 〈 {Z}_{ki} 〉 + {\sum }_{i ∈ {Ω}_{j}^{c}} 〈 {X}_{ij} {Z}_{ki} 〉 , \\ {α}_{kj} = {α}_{0} - {\sum }_{i = 1}^{I} 〈 {Z}_{ki} 〉 + {ξ}_{kj} , \\ {b}_{kj} = {b}_{0} + V {\sum }_{i = 1}^{I} 〈 {Z}_{ki} 〉 - {ξ}_{kj} , \\ 〈 {β}_{kj} 〉 = {α}_{kj} \text{/} ( {a}_{kj} + {b}_{kj} ) , \\ 〈 log {β}_{kj} 〉 = ψ ( {a}_{kj} ) - ψ ( {a}_{kj} + {b}_{kj} ) , \\ 〈 log ( 1 - {β}_{kj} ) 〉 = ψ ( {b}_{kj} ) - ψ ( {a}_{kj} + {b}_{kj} ) & [ Equation 23 ]\end{matrix}$$

Here, the equation 22 is the parametric function for β, and the equation 23 is an update formula for β.

$$\begin{matrix}q ( μ ) = {\prod }_{i = 1}^{I} Beta ( {μ}_{i} \vert {c}_{i} , {d}_{i} ) & [ Equation 24 ] \\ for i ∈ \{ 1 , … , I \} \\ {ξ}_{i} = {\sum }_{j ∈ {Ω}_{i}} 〈 {I}_{ij} 〉 \\ {c}_{i} = {c}_{0} + {ξ}_{i} , \\ {d}_{i} = {d}_{0} + J - {ξ}_{i} , \\ 〈 {μ}_{i} 〉 = {c}_{i} \text{/} ( {c}_{i} + {d}_{i} ) , \\ 〈 log {μ}_{i} 〉 = ψ ( {c}_{i} ) - ψ ( {c}_{i} + {d}_{i} ) , \\ 〈 log ( 1 - {μ}_{i} ) 〉 = ψ ( {d}_{i} ) - ψ ( {c}_{i} + {d}_{i} ) & [ Equation 25 ]\end{matrix}$$

Here, the equation 24 is the parametric function for μ, and the equation 25 is an update formula for μ. Also, f is a set of a plurality of products whose preference ratings are observed for the i-th user.

$$\begin{matrix}q ( v ) = {\prod }_{j = 1}^{J} Beta ( {j}_{j} \vert {e}_{j} , {f}_{j} ) & [ Equation 26 ] \\ for j ∈ \{ 1 , … , J \} \\ {ξ}_{j} = {\sum }_{i ∈ {Ω}_{j}} 〈 {M}_{ij} 〉 \\ {e}_{j} = {e}_{0} + {ξ}_{j} , \\ {f}_{j} = {f}_{0} + I - {ξ}_{j} , \\ 〈 {v}_{j} 〉 = {e}_{j} \text{/} ( {e}_{j} + {f}_{j} ) , \\ 〈 log {v}_{j} 〉 = ψ ( {e}_{j} ) - ψ ( {e}_{j} + {f}_{j} ) , \\ 〈 log ( 1 - {v}_{j} ) 〉 = ψ ( {e}_{j} ) - ψ ( {e}_{j} + {f}_{j} ) & [ Equation 27 ]\end{matrix}$$

Here, the equation 26 is the parametric function for ν, and the equation 27 is an update formula for ν. Also, Ωⱼ is a set of a plurality of users whose preference ratings are observed for the j-th product.

$$\begin{matrix}q ( γ ) = {\prod }_{v = 1}^{V} Beta ( {γ}_{v} \vert {g}_{v} , {h}_{v} ) & [ Equation 28 ] \\ for v ∈ \{ 1 , … , V \} \\ {ξ}_{v} = {\sum }_{( i , j ) ∈ {Ω}_{v}} 〈 {T}_{ij} 〉 \\ {g}_{v} = {g}_{0} + {ξ}_{v} , \\ {h}_{v} = {f}_{0} + {H}_{v} - {ξ}_{v} , \\ 〈 {γ}_{v} 〉 = {g}_{v} \text{/} ( {g}_{v} + {h}_{v} ) , \\ 〈 log {γ}_{v} 〉 = ψ ( {g}_{v} ) - ψ ( {g}_{v} + {h}_{v} ) , \\ 〈 log ( 1 - {γ}_{v} ) 〉 = ψ ( {h}_{j} ) - ψ ( {g}_{v} + {h}_{v} ) & [ Equation 29 ]\end{matrix}$$

Here, the equation 28 is the parametric function for γ, and the equation 29 is an update formula for γ. Also, Ωᵥ is a set of a plurality of user-product entries (i,j) to which preference rating v is inputted.

$$\begin{matrix}q ( {X}_{{Ω}^{c}} , Z ) = {\prod }_{i = 1}^{I} q ( {X}_{{Ω}_{i}^{c}} \vert {z}_{i} ) q ( {z}_{i} ) \\ q ( {X}_{{Ω}_{i}^{c}} \vert {z}_{i} ) = {Π}_{j ∈ {Ω}_{j}^{c}} {q ( {X}_{ij} \vert {z}_{i} )}^{δ ( {X}_{ij} = v )} \\ q ( {X}_{ij} = v \vert {z}_{i} ) = {( {λ}_{kjv} )}^{{Z}_{ki}} \\ q ( {z}_{i} ) = {\prod }_{k = 1}^{K} {( {ρ}_{ki} )}^{{Z}_{ki}} & [ Equation 30 ] \\ {λ}_{kjv} = exp ( \tilde{{λ}_{kjv}} ) \text{/} {\sum }_{{v}^{′} = 1}^{V} exp ( \tilde{{λ}_{{kjv}^{′}}} ) \\ \tilde{{λ}_{kjv}} = 〈 log ( 1 - {γ}_{v} ) 〉 + log ( \begin{matrix}V - 1 \\ v - 1\end{matrix} ) + v 〈 log {β}_{kj} 〉 + ( V - v ) 〈 log ( 1 - {β}_{kj} ) 〉 \\ {ρ}_{ki} = exp ( \tilde{{ρ}_{ki}} ) \text{/} {\sum }_{{k}^{′} = 1}^{K} exp ( \tilde{{ρ}_{{ki}^{′}}} ) \\ \tilde{{ρ}_{ki}} = 〈 log {θ}_{k} 〉 + {\sum }_{i ∈ {Ω}_{i}} [ {X}_{ij} 〈 log {β}_{kj} 〉 + ( V - {X}_{ij} ) 〈 log ( 1 - {β}_{kj} ) 〉 ] + {\sum }_{j ∈ {Ω}_{i}^{c}} ( \tilde{{φ}_{kj}} + \tilde{{φ}_{kj}} - \tilde{{φ}_{kj}} ) \\ {φ}_{kj} = {\sum }_{v = 1}^{V} ( v - 1 ) {λ}_{kjv} \\ \overline{{φ}_{kj}} = {\sum }_{v = 1}^{V} 〈 log ( 1 - {γ}_{v} ) 〉 {λ}_{kjv} \\ \hat{{φ}_{kj}} = {\sum }_{v = 1}^{V} {λ}_{kjv} log {λ}_{kjv} \\ \tilde{{φ}_{kj}} = {φ}_{kj} 〈 log {β}_{kj} 〉 + ( V - 1 - {φ}_{kj} ) + {\sum }_{v = 1}^{V} {λ}_{kjv} log ( \begin{matrix}V - 1 \\ v - 1\end{matrix} ) & [ Equation 31 ]\end{matrix}$$

Here, the equation 30 is the parametric function for X_{Ω}_{^{C}} and Z, and the equation 31 is an update formula for X_{Ω}_{^{C}} and Z. Also, [symbol] Zₖᵢ [symbol] and [symbol] XᵢⱼZₖᵢ [symbol] used in the equation 23 may be calculated as a below equation 32 by using the result of the equation 31.

$$\begin{matrix}〈 {Z}_{ki} 〉 = {ρ}_{ki} & [ Equation 32 ] \\ 〈 {X}_{ij} {Z}_{ki} 〉 = {\sum }_{v = 1}^{V} ( v - 1 ) q ( {X}_{ij} = v \vert {Z}_{ki} = 1 ) q ( {Z}_{ki} = 1 ) = {\sum }_{v = 1}^{V} ( v - 1 ) {λ}_{kjv} {ρ}_{ki} = {φ}_{kj} {ρ}_{ki} \\ q ( {U}_{Ω} , {M}_{Ω} , {T}_{Ω} ) = {Π}_{( i , j ) ∈ Ω} q ( {U}_{ij} , {M}_{ij} , {T}_{ij} ) \\ where , \\ q ( {U}_{ij} , {M}_{ij} < {T}_{ij} ) = \frac{{( \tilde{{μ}_{i}^{1}} )}^{{U}_{ij}} {( \tilde{{μ}_{i}^{0}} )}^{1 - {U}_{ij}} {( \tilde{{v}_{j}^{1}} )}^{{M}_{ij}} {( \tilde{{v}_{j}^{0}} )}^{1 - {M}_{ij}} {( \tilde{{γ}_{{X}_{ij}}^{1}} )}^{{T}_{ij}} {( \tilde{{γ}_{{X}_{ij}}^{0}} )}^{1 - {T}_{ij}}}{( \tilde{{μ}_{i}^{1}} + \tilde{{μ}_{i}^{0}} ) ( \tilde{{v}_{j}^{1}} + \tilde{{v}_{j}^{0}} ) ( \tilde{{γ}_{{X}_{ij}}^{1}} + \tilde{{γ}_{{X}_{ij}}^{0}} ) - \tilde{{μ}_{i}^{0}} \tilde{{v}_{j}^{0}} \tilde{{γ}_{{X}_{ij}}^{0}}} \\ for ( {U}_{ij} , {M}_{ij} , {T}_{ij} , ) ∈ {\{ 0 , 1 \}}^{3} - ( 0 , 0 , 0 ) . & [ Equation 33 ] \\ \tilde{{μ}_{i}^{1}} = exp ( 〈 log {μ}_{i} 〉 ) \\ \tilde{{μ}_{i}^{0}} = exp ( 〈 log ( 1 - {μ}_{i} ) 〉 ) \\ \tilde{{v}_{j}^{1}} = exp ( 〈 log {v}_{j} 〉 ) \\ \tilde{{v}_{j}^{0}} = exp ( 〈 log ( 1 - {v}_{j} ) 〉 ) \\ \tilde{{γ}_{v}^{1}} = exp ( 〈 log {γ}_{v} 〉 ) \\ \tilde{{γ}_{v}^{0}} = exp ( 〈 log ( 1 - {γ}_{v} ) 〉 ) & [ Equation 34 ]\end{matrix}$$

Here, the equation 33 is the parametric function for U_{Ω}, M_{Ω}, and T_{Ω}, and the equation 34 is an update formula for U_{Ω}, M_{Ω}, and T_{Ω}. Also, [symbol] Uᵢⱼ [symbol] , [symbol] Mᵢⱼ [symbol] , and [symbol] Tᵢⱼ [symbol] used in the equations 24 to 29 may be calculated as a below equation 35 by using the result of the equation 34.

$$〈 {U}_{ij} 〉 = q ( {U}_{ij} = 1 ) = \frac{\tilde{{μ}_{i}^{1}} ( \tilde{{v}_{j}^{1}} + \tilde{{v}_{j}^{0}} ) ( \tilde{{γ}_{{X}_{ij}}^{1}} + \tilde{{γ}_{{X}_{ij}}^{0}} )}{( \tilde{{μ}_{i}^{1}} + \tilde{{μ}_{i}^{0}} ) ( \tilde{{v}_{j}^{1}} + \tilde{{v}_{j}^{0}} ) ( \tilde{{γ}_{{X}_{ij}}^{1}} + \tilde{{γ}_{{X}_{ij}}^{0}} ) - \tilde{{μ}_{i}^{1}} \tilde{{v}_{j}^{1}} \tilde{{γ}_{{X}_{ij}}^{1}}} \\ 〈 {M}_{ij} 〉 = q ( {M}_{ij} = 1 ) = \frac{( \tilde{{μ}_{i}^{1}} + \tilde{{μ}_{i}^{0}} ) \tilde{{v}_{j}^{1}} ( \tilde{{γ}_{{X}_{ij}}^{1}} + \tilde{{γ}_{{X}_{ij}}^{0}} )}{( \tilde{{μ}_{i}^{1}} + \tilde{{μ}_{i}^{0}} ) ( \tilde{{v}_{j}^{1}} + \tilde{{v}_{j}^{0}} ) ( \tilde{{γ}_{{X}_{ij}}^{1}} + \tilde{{γ}_{{X}_{ij}}^{0}} ) - \tilde{{μ}_{i}^{1}} \tilde{{v}_{j}^{1}} \tilde{{γ}_{{X}_{ij}}^{1}}} \\ 〈 {T}_{ij} 〉 = q ( {T}_{ij} = 1 ) = \frac{( \tilde{{μ}_{i}^{1}} + \tilde{{μ}_{i}^{0}} ) ( \tilde{{v}_{j}^{1}} + \tilde{{v}_{j}^{0}} ) \tilde{{γ}_{{X}_{ij}}^{1}}}{( \tilde{{μ}_{i}^{1}} + \tilde{{μ}_{i}^{0}} ) ( \tilde{{v}_{j}^{1}} + \tilde{{v}_{j}^{0}} ) ( \tilde{{γ}_{{X}_{ij}}^{1}} + \tilde{{γ}_{{X}_{ij}}^{0}} ) - \tilde{{μ}_{i}^{1}} \tilde{{v}_{j}^{1}} \tilde{{γ}_{{X}_{ij}}^{1}}} \qquad [ Equation 35 ]$$

Preference Prediction for Missing Data

Preferences for missing data Xᵢⱼ may be predicted based on the learned model as a below equation 36.

$$\begin{matrix}〈 {X}_{ij} 〉 = {\sum }_{v = 1}^{V} vq ( {X}_{ij} = v ) \\ = {\sum }_{v = 1}^{V} v {\sum }_{k = 1}^{K} q ( {X}_{ij} = v \vert {Z}_{ki} = 1 ) q ( {Z}_{ki} = 1 ) \\ = {\sum }_{v = 1}^{V} v {\sum }_{k = 1}^{K} {λ}_{kjv} {ρ}_{ki}\end{matrix} \qquad [ Equation 36 ]$$

Performance Comparison

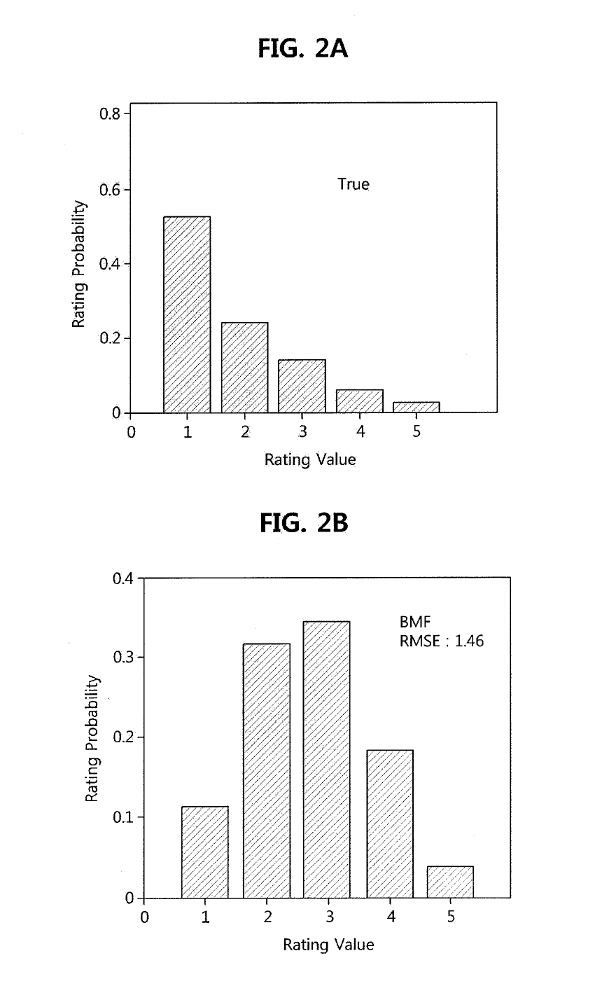

FIGS. 2A to 2D are graphs illustrating comparison between results of preference prediction using the binominal mixture model based analysis model according to an exemplary embodiment of the present disclosure and results of preference prediction according to a comparative method.

Referring to FIGS. 2A to 2D, based on data of ‘Yahoo! Music ratings for User Selected and Randomly Selected songs, version 1.0’, preference prediction performance of the exemplary embodiment according to the present disclosure and those of the comparative methods are compared.

The data used in the experiment is constructed to measure performances of collaborative filtering techniques based on the assumption of MNAR. The used user preference data were composed in the below manners (1) and (2).

(1) data “ratings for user selected item”—311,704 ratings performed by 15,400 users for songs selected by the users among 1,000 songs.

(2) data “ratings for randomly selected songs”—54,000 ratings performed by 15,400 users respectively for 10 randomly selected songs.

Also, the experiment was performed through the below steps 1 and 2.

(1) model learning by using the data

(2) prediction performance measurement for the data

The prediction performance (rating probability) may be represented as a root mean squared error (RMSE) for each rating value having a value of one of 1 to 5.

FIG. 2A illustrates a histogram of true missing data.

FIG. 2B illustrates prediction results according to a Bayesian matrix factorization (BMF) model. The BMF model is based on the MAR assumption, and ignores a missing data mechanism. The prediction performance of the BMF model is RMSE 1.46.

FIG. 2C illustrates prediction results of a multinomial mixture/CPT-v model. The multinomial mixture/CPT-v model has been proposed in the below reference.
[Reference 3] B. M. Marlin and R. S. Zemel, “Collaborative prediction and ranking with non-random missing data”, In Proceedings of the ACM International Conference on Recommender Systems, New York, N.Y., USA, 2009.

Although the multinomial mixture/CPT-v model is based on the MNAR assumption, it considers only the rating-value based selection effect in the missing data mechanism. The prediction performance of the multinomial mixture/CPT-v model is RMSE 1.12 and better than that of the BMF model. However, the histogram of the predicted ratings shows abnormal results in which most of rating values are biased to 2.

FIG. 2D illustrates prediction results of a binomial mixture/OR (BM/OR) model proposed in an exemplary embodiment according to the present disclosure. The prediction performance of the BM/OR model is RMSE 0.98, and excellent as compared to those of comparative methods remarkably. Also, the histogram of the predicted ratings is similar to that of the actual missing data of FIG. 2A.

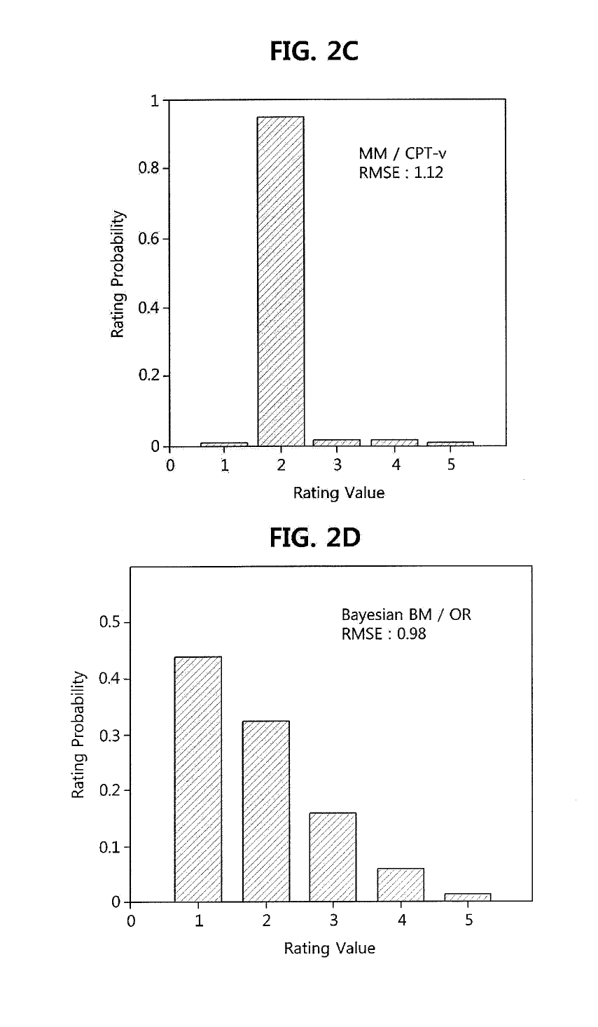

FIG. 3 is a block diagram illustrating a MNAR data analysis apparatus according to another exemplary embodiment of the present disclosure.

Referring to FIG. 3, the MNAR data analysis apparatus 10 (hereinafter, referred to as ‘data analysis apparatus’) according to an exemplary embodiment of the present disclosure may comprise a memory unit 12 and a processor 11 for executing a program stored in the memory unit 12 and analyzing MNAR data. Also, the data analysis apparatus 10 may further comprise at least one of a network interface 13, a display apparatus 14, and an interface 15.

The data analysis apparatus 10, as an apparatus performing the above-described MNAR data analysis, may use the above-described binomial mixture model or Bayesian binomial mixture model.

In the processor 11, one or more modules for analyzing MNAR data based on the binomial mixture model may be executed. For example, the one or more modules may include a first module 11a which defines a binomial mixture model based data generation model for analyzing user preference data on products, a second module 11b which defines a missing data mechanism model for explaining observation and missing of user preference data on products, a third module 11c which performs learning of the data generation module and the missing data mechanism model based on the observed user preference data on products, a fourth module 11d which determines final preferences of products whose ratings are missing based on the learned data generation model and the learned missing data mechanism model, and a fifth module 11e which analyzes a trend of observed data based on the learned data generation model and the learned missing data mechanism model.

The first module 11a may comprise means for defining a probability model used for analyzing MNAR data or a component performing the function of the means. The second module 11b may comprise means for defining an analysis model by assigning a priori distribution to variables constituting the probability model or a component performing the function of the means. The third module 11c may comprise means for performing learning of the analysis model through inference on the variables constituting the analysis model based on a variational method or a component performing the function of the means. The fourth module 11d may comprise means for predicting missing data based on the learned analysis model or a component performing the function of the means.

The above-described processor 11 may comprise an arithmetic logic unit (ALU) performing computation, registers for temporarily storing data and instruction commands, and a controller for controlling or managing the above units. The processor 11 may load at least one of the first to fifth modules 11a to 11e into predetermined regions of the registers and the memory unit, analyze MNAR data through operations of respective modules or inter-operations between them, and output s results of the analysis.

The processor 11 may be a microprocessor, a central processing unit (CPU), or a graphic processing unit (GPU). For example, the processor 11 may have one of various architectures such as Alpha of Digital corporation, MIPS of MIPS technology corporation, NEC corporation, IDT corporation, or Siemens corporation, x86 of Intel, Cyrix, A M D, and Nexgen, and PowerPC of IBM and Motorola.

The memory unit 12 may store the MNAR data and the program for implementing the binary mixture model based data analysis method. The memory unit 12 may include a main memory such as a Random Access Memory (RAM) and a Read-Only Memory (ROM), and a secondary memory which is a long-term storage medium such as a Floppy disc, hard disc, tape, CD-ROM, and Flash memory. The memory unit 12 may include a recording medium on which the program code for executing methods for analyzing MNAR data according to exemplary embodiments of the present disclosure are recorded.

The network interface 13 may comprise means for connecting to a network and performing data communications or a component performing the function of the means. The network interface 13 may be connected to a specific external service provision server on the network and collect or mediate MNAR data of the service provision server. Such the network interface 13 may be implemented to support at least one of communication protocols using one or more of a wireless network, a wire network, a satellite network, and a power line communication network.

The display apparatus 14 may comprise means for displaying analysis procedures or results of the MNAR data analysis based on the binomial mixture model while connecting to the processor 11 or a component performing the function of the means. The display apparatus 14 may be directly to the processor 11. However, without being restricted thereto, the display apparatus 14 may be connected to a remote facility via the network interface 13. A liquid crystal display (LCD) apparatus, an organic light emitting diode (OLED) display apparatus, a plasma display panel (PDP) apparatus, a project or a cathode ray tube (CRT) may be used as the display apparatus 14.

The interface 15 may comprise means for connecting to the processor 11 and performing interaction between the data analysis apparatus 10 and external entities or a component perform the function of the means. The interface 15 may include, as an input device, at least one of a keyboard, a mouse, a touch screen, a touch panel, and a microphone. Also, the interface 15 may include, as an output device, at least one of a speaker, an illuminating unit, a vibrating unit, and a display unit.

Meanwhile, the data analysis apparatus 10 according to an exemplary embodiment is a representative implementation of an apparatus for analyzing data based on the binomial mixture model. The present disclosure is not restricted thereto.

For example, the data analysis apparatus 10 or the modules executing functions of the data analysis apparatus 10 may be implemented on a computer-readable recording medium storing program codes which can be executed by various computer apparatuses. In this case, the computer-readable recording medium may store the program executing the above-described steps of the MNAR data analysis method.

Also, the computer-readable recording medium may include a memory device which can store the program codes, such as a ROM, a RAM, or a flash memory. The program codes may include machine language codes compiled by a compiler or high-level language codes executed by an interpreter.

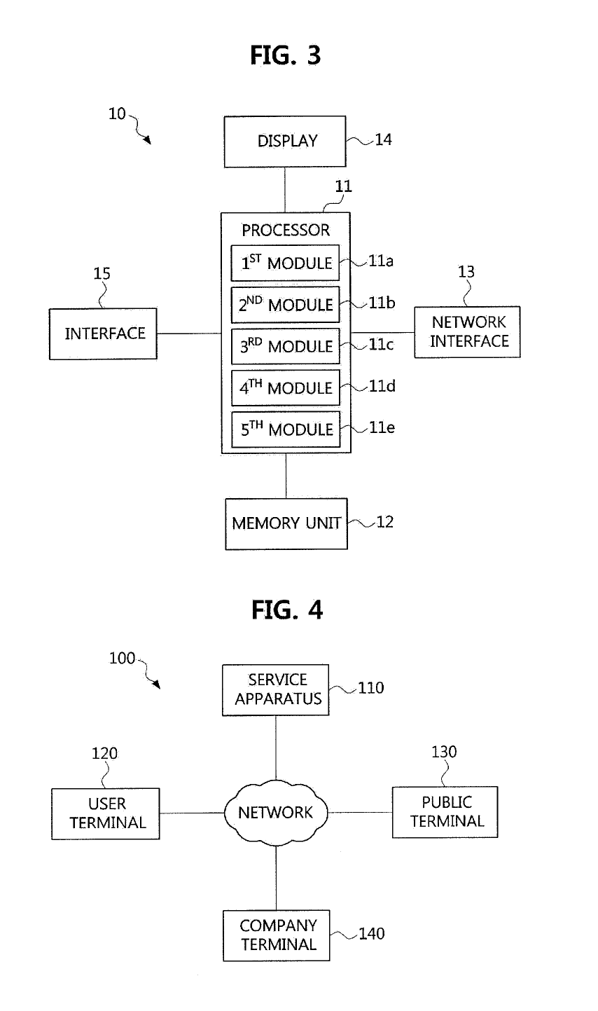

FIG. 4 is a block diagram illustrating a product recommendation system using MNAR data analysis methods or apparatuses according to an exemplary embodiment of the present disclosure.

Referring to FIG. 4, the product recommendation system 100 may comprise a service apparatus 110, and the service apparatus 110 may be connected to various terminals via a network. Here, the terminals may include a user terminal 120, a public terminal 130, and a company terminal 140. Here, the service apparatus 110 may comprise the data analysis apparatus 10 of FIG. 3 as a core component of the product recommendation system 100.

For analysis of MNAR data, the service apparatus 110 may define a binomial mixture model based data generation model for analyzing user preference data on products, define a missing data mechanism model for explaining observation and missing of user preference data on products, perform learning of the data generation module and the missing data mechanism model based on the observed user preference data on products, and determine final preferences of products whose ratings are missing or analyze trends of observed data based on the learned data generation model and the learned missing data mechanism model.

Also, the service apparatus 110 may provide product recommendation information extracted from the final preferences of products to the user terminal 120, the public terminal 130, or the company terminal 140. Furthermore, the service apparatus 110 may provide product recommendation information extracted from the result of trend analysis on the observed data based on the learned data generation model and the learned missing data mechanism model to the user terminal 120, the public terminal 130, or the company terminal 140.

For provisioning the product recommendation information, the service apparatus 110 may directly provide the corresponding information to the terminal in response to a request of the terminal. However, without being restricted thereto, the service apparatus 110 may provide the information to the terminal 120, 130, or 140 periodically or aperiodically by using a push messaging or similar functions.

The product recommendation information may include identifiers or unique information for specifying at least one of products or services among a plurality of products and services. Also, the product recommendation information may be converted into information having various formats according to types of the terminal.

The user terminal 120 may include a personal computer, a laptop computer, a personal digital assistant (PDA), a tablet PC, a smart phone, etc. That is, the user terminal 120 may be any kind of digital devices which can access a communication network.

The public terminal 130 may be installed in a position where a plurality of users can easily access, and may include an apparatus providing advertisement information, alarm information, notice information, or any other information to the plurality of users through communications with the service apparatus 110. For example, the public terminal 130 may be a digital signage apparatus.

Also, the company terminal 140 is a terminal belonging to a company providing products or services. The company terminal 140 may mean an apparatus which is connected to the service apparatus 110, and receives the product recommendation information from the service apparatus 110. Such the company terminal 140 may be used for a sales manager or system to modify or update sales policy of the company through provision of the product recommendation information.

The above-described pubic terminal 130 and company terminal 140 may include an electronic apparatus which can access a communication network, at least one of a personal computer, a laptop computer, a display apparatus, a server apparatus, a projector, or a digital signage apparatus.

While the example embodiments of the present invention and their advantages have been described in detail, it should be understood that various changes, substitutions and alterations may be made herein without departing from the scope of the invention.

What is claimed is:

1. A missing not at random (MNAR) data analysis method based on a binomial mixture model, the method comprising:
defining a binomial mixture model based data generation model for analyzing user preference data on products;
defining a missing data mechanism model for explaining observation and missing of user preference data on the products;
learning the data generation model and the missing data mechanism model based on observed user preference data on the products; and
determining final preferences on products whose preferences are missing based on the learned data generation model and the learned missing data mechanism model.

2. The method according to claim 1, wherein the binomial mixture model based data generation model is defined based on assumption that users are grouped into a plurality of groups having similar preferences, assumption that user preferences on products follow a binomial distribution model, and assumption that users belonging to a same group share parameters of the binomial distribution model.

3. The method according to claim 1,
wherein the missing data mechanism model is based on three factors including user activities, popularities of products, and rating value based selection effects, and the three factors are represented as binary variables, and
wherein whether a specific user's preference on a specific product is observed or missing is determined through a Boolean OR operation on the three factors.

4. The method according to claim 1, wherein the learning the data generation model and the missing data mechanism model comprises:
representing a posterior distribution of random variables constituting probability models of the data generation model and the missing data mechanism model as multiplication of parametric functions respectively defined for the random variables through mean field approximation based on variational inference;
extracting a lower-bound function of marginalized log likelihood for observed variables based on the parametric functions; and
learning parameters of the parametric functions maximizing the extracted lower-bound function.

5. The method according to claim 4, wherein, in the learning parameters of the parametric functions, a plurality of parameters included in the parametric functions are sequentially updated until a change amount of the lower-bound function of marginalized log likelihood becomes less than a threshold.

6. The method according to claim 1, further comprising analyzing a trend of the observed user preference data based on the learned data generation model and missing data mechanism model.

7. A missing not at random (MNAR) data analysis method based on a binomial mixture model, the method comprising:
defining probability models for analyzing the MNAR data and defining an analysis model by assigning a posteriori distribution to variables constituting the probability models;
learning the analysis model through a variational inference for respective variables constituting the analysis model; and
predicting missing data based on the learned analysis model,
wherein the probability models include a binomial mixture model based data generation model and a missing data mechanism explaining observation and missing of user preference data on products.

8. The method according to claim 7, further comprising determining final preferences on products whose preferences are missing based on the predicted missing data.

9. The method according to claim 7, further comprising analyzing a trend of observed user preference data based on the predicted missing data.

10. The method according to claim 7, further comprising transmitting product recommendation information including final preferences determined for products whose preferences are missing based on the predicted missing data or product recommendation information including a trend of observed user preference data analyzed based on the predicted missing data.

11. A data analysis apparatus for analyzing missing not at random (MNAR) data based on a binomial mixture model, the apparatus comprising:
a memory unit storing a program code; and
a processor which is connected to the memory unit and executes the program code,
wherein the program code includes
a step of defining probability models for analyzing the MNAR data and defining an analysis model by assigning a posteriori distribution to variables constituting the probability models;
a step of learning the analysis model through a variational inference for respective variables constituting the analysis model; and
a step of predicting missing data based on the learned analysis model,
wherein the probability models include a binomial mixture model based data generation model and a missing data mechanism explaining observation and missing of user preference data on products.

12. The apparatus according to claim 11, wherein the program code further comprises a step of determining final preferences on products whose preferences are missing based on the predicted missing data.

13. The apparatus according to claim 11, wherein the program code further comprises a step of analyzing a trend of observed user preference data based on the predicted missing data.

14. The apparatus according to claim 11, wherein the program code further comprise a step of transmitting product recommendation information including final preferences determined for products whose preferences are missing based on the predicted missing data or product recommendation information including a trend of observed user preference data analyzed based on the predicted missing data.

15. A product recommendation system including a service apparatus for analyzing missing not at random (MNAR) data based on a binomial mixture model,
wherein the service apparatus defines probability models for analyzing the MNAR data and defining an analysis model by assigning a posteriori distribution to variables constituting the probability models, learns the analysis model through a variational inference for respective variables constituting the analysis model, and predicts missing data based on the learned analysis model, and
wherein the probability models include a binomial mixture model based data generation model and a missing data mechanism explaining observation and missing of user preference data on products.

16. The product recommendation system according to claim 15, wherein the service apparatus transmits, to a terminal in a network, product recommendation information including final preferences determined for products whose preferences are missing based on the predicted missing data or product recommendation information including a trend of observed user preference data analyzed based on the predicted missing data.

17. The product recommendation system according to claim 15, wherein the service apparatus defines the binomial mixture model based data generation model based on assumption that users are grouped into a plurality of groups having similar preferences, assumption that user preferences on products follow a binomial distribution model, and assumption that users belonging to a same group share parameters of the binomial distribution model.

18. The product recommendation system according to claim 17,
wherein the service apparatus defines the missing data mechanism model based on three factors including user activities, popularities of products, and rating value based selection effects, and the three factors are represented as binary variables, and
wherein whether a specific user's preference on a specific product is observed or missing is determined through a Boolean OR operation on the three factors.

19. The product recommendation system according to claim 15, wherein the service apparatus represents a posterior distribution of random variables constituting probability models of the data generation model and the missing data mechanism model as multiplication of parametric functions respectively defined for the random variables through mean field approximation based on variational inference, extracts a lower-bound function of marginalized log likelihood for observed variables based on the parametric functions, and learns parameters of the parametric functions maximizing the extracted lower-bound function.
